(19) United States
(12) Patent Application Publication
(10) Pub. No.: US 2008/0230298 A1
(43) Pub. Date: Sep. 25, 2008

(54) Method of Applying Oral Compositions

(76) Inventors: Robert Michael Buch, Parsippany, NJ (US); Robert J. Gambogi, Parsippany, NJ (US); Peter R. Huie, Parsippany, NJ (US)

Correspondence Address: SMITHKLINE BEECHAM CORPORATION;CORPORATE INTELLECTUAL PROPERTY-US, UW2220, P. O. BOX 1539, KING OF PRUSSIA, PA, 19406-0939, US

(21) Appl. No.: 10/572,272

(22) PCT Filed: Sep. 15, 2004
(86) PCT No.: PCT/US04/30273

§ 371 Date: Mar. 15, 2006

Related U.S. Application Data
(60) Provisional application No. 60/504,014, filed on Sep. 18, 2003.

(51) Int. Cl. B62D 21/00

(52) U.S. Cl. 180/311

(57) ABSTRACT

A method of applying oral compositions to the temporary and permanent surfaces of the oral cavity comprising the step of obtaining a container and applicator combination formed as an assembly that comprises an internal region that contains an oral care composition and an externally projecting pair of spreadable wings, expelling said oral care composition from said internal region and spreading said oral care composition onto the surfaces of the oral cavity with said spreadable wings.

### FIELD OF THE INVENTION

This invention relates to methods of applying oral compositions to the temporary and permanent surfaces of the oral cavity. More particularly, this invention relates to a method of using a disposable applicator that is suitable for storing and spreading a small measured quantity of an composition, to apply oral care compositions to the temporary and permanent surfaces of the oral cavity.

### BACKGROUND

Bacterial plaque is the primary cause of gum disease and tooth decay. Plaque is a sticky, colorless film of bacteria that constantly forms on your teeth and gums. Consuming foods high in carbohydrates, such as sugars and starches, can cause these bacteria to create acids which can, over time, damage the teeth and gums. In addition, certain types of plaque bacteria create toxins that can injure the gums and underlying bone.

Plaque that is not removed from the hard dental surfaces can combine with other materials and harden into a rough, porous deposit called calculus or tartar. Once calculus has formed, intervention by a dental professional is typically required to remove the hardened deposit. Calculus that forms above the gum line is primarily a cosmetic concern, causing teeth to appear stained and unsightly. Calculus that extends below the gum line is more difficult to remove completely and, therefore, may lead to the development of periodontal disease and ultimately, tooth loss.

To maintain proper oral hygiene and prevent plaque and subsequent calculus build up on the teeth, the teeth should be cleaned at regular and frequent intervals. The American Dental Association recommends a oral hygiene regimen which includes brushing one's teeth at least twice a day with a fluoride containing toothpaste and a soft bristled toothbrush combined with cleaning between teeth by flossing at least once per day. However, often times it is desirable to brush or otherwise clean the teeth after meals or even snacks. This is particularly important when foods containing high levels of sugars and starches are consumed.

Unfortunately, the use of a conventional toothbrush and toothpaste to clean the teeth may not always be convenient after mealtimes and snacking. Toothbrush and toothpaste articles are typically large, bulky and can become messy after use. Therefore, the average consumer may be disinclined to carry a conventional toothbrush and toothpaste tube for such oral maintenance purposes.

Various disposable oral care toothbrushes and other cleansing devices, such as dental wipes, dental ‘dots’ pre-impregnated with a dentifrice composition, disposable toothbrush heads designed to be adhered to the finger, and the like are known. See, for example, U.S. Pat. Nos. 3,905,113; 3,934,299; 3,070,102; 3,298,507; 3,902,509; 4,875,247; 5,107,562; 5,487,201; 5,678,273; 5,794,774; 6,464,103.

Despite the various disposable oral cleaning devices that have been previously developed, there remains a need for additional, convenient, methods for an individual to apply oral care compositions to the permanent and temporary surfaces of the oral cavity to ensure good dental hygiene throughout the day.

Applicant has surprisingly discovered a method for applying an oral care composition with a container and applicator combination package. The container and applicator combination contemplated for use in the present invention is more particularly described in U.S. Pat. No. 6,007,264 to Koptis, which is incorporated herein by reference in its entirety. Packages of this type are manufactured by Cardinal Healthcare under the tradename DelPouch®. However, Applicant has surprisingly discovered that due to its pliable nature, this particular package-type works very well for the compact yet intricate surfaces of the oral cavity.

### SUMMARY OF THE INVENTION

The present invention relates to a method of applying oral compositions to the temporary and permanent surfaces of the oral cavity comprising the step of obtaining a container and applicator combination formed as an assembly that comprises an internal region that contains an oral care composition and an externally projecting pair of speadable wings, expelling said oral care composition from said internal region and spreading said oral care composition onto the surfaces of the oral cavity with said spreadable wings.

### BRIEF DESCRIPTION OF THE DRAWINGS

FIG. 1 illustrates a preferred embodiment of the invention.

FIG. 2 illustrates the embodiment of FIG. 1 in side view.

FIGS. 3, 4 and 5 illustrate the techniques for operation of the embodiment of FIG. 1 and also the other embodiments presented herein.

FIGS. 6, 7, 8 and 9 partially illustrates steps in a preferred procedure of fabricating the embodiment of FIG. 1.

FIG. 8a illustrates a substitute component for a component illustrated in the step of FIG. 8.

FIG. 10 illustrates another embodiment of the invention.

FIG. 11 is a section view of the embodiment of FIG. 10.

FIG. 12 illustrates the embodiment of FIG. 10 in side view.

FIG. 13 is a partial perspective view of the embodiment of FIG. 10 ready for operation.

FIG. 14 illustrates still another embodiment of the invention in which the dispensable ingredient is confined in a shallow sack.

FIG. 15 is a section view of an alternative embodiment that incorporates a wall stiffening element.

FIG. 16 is a section view of another embodiment whose walls and flaps are formed of materials of different thickness and stiffness.

FIGS. 17 and 18 illustrate embodiments of circular and diamond shape.

FIG. 19 is a pictorial view of the top of still another embodiment of the invention.

FIG. 20 illustrates the embodiment of FIG. 19 in perspective view.

FIGS. 21, 22 and 23 are perspective illustrations of the embodiment of FIG. 19 in various stages of assembly.

### DETAILED DESCRIPTION OF THE INVENTION

The present invention relates to a method of applying an oral composition to any of the temporary or permanent surfaces of the oral cavity comprising the steps of obtaining a container and applicator combination formed as an assembly that comprises an internal region that contains an oral care composition and an externally projecting pair of speadable wings, expelling said oral care composition from said internal region and spreading said oral care composition onto the surfaces of the oral cavity with said spreadable wings.

In one embodiment the container and applicator combination employed in the present method may be formed with a pair of flexible foil sheets of substantially identical structure that are superimposed over one another and partially connected together to define there between both an internal region for confining a spreadable substance and an applicator for spreading that substance upon a surface. By pressing the sides of the internal region, the confined fluid ingredients are expressed onto the applicator and/or onto the desired surface. Then, using the container portion as a finger grip, the applicator is moved by hand about the surface to spread the dispensed ingredient over the intended surface. The bond between the foil sheets is strong enough to prevent the sheets from separated by pulling apart the flaps with excessive force; and the oral care composition can be expressed only through a desired outlet.

The foil sheets may be joined together with thermal seams by thermo-sealing as in the prior art packages to define one or more compartments, depending upon the particular application. Confronting end portions of those sheets located at the outlet to a compartment provide wings or flaps that function as the applicator.

In one embodiment the applicator is formed of the ends of the flexible foil sheets, which, left free to pivot, form confronting flaps that may swing outwardly in opposite directions, with the outlet to the container portion located there between. And in alternative embodiments, as an additional feature, the applicator portion of the sheets includes a cleaning surface such as a clothlike absorbent pad, a plurality of bristles, a sponge, or the like. The cleaning surface provides a soft, contourable polishing surface instead of the foil surface and/or provides a sponge like action to suck up expressed liquid and apply it to the surface. A variety of means may be employed to open the dispensing outlet in various embodiments, including squeezing the packages sides, pulling the applicator flaps, tearing, or simply by unfolding the applicator from a stored position.

The container and applicator combination (the “package”) employed within the present invention is adapted to numerous embodiments that vary in construction, structure and features, more particularly understood with reference to the drawing. Beginning this description with one of the more complex embodiments, reference is first made to FIG. 1 illustrating a preferred embodiment of the package 1 in top view and is in-turn packaged in a sealed wrap. As illustrated the package contains a container section 3, represented in this embodiment by the generally rectangular portion. That container section is in turn divided into two separate compartments 3A and 3B, illustrated as being filled with ingredients 2A and 2B, respectively. A wing or flap 5 is integrally formed at the narrow end of the container section 3. The flap is semi-circular in shape and contains no shape corners as might catch on a surface. And, preferably, a fold line 13 is included between the flap and the container section.

A thin absorbent layer or, as variously termed, pad 7, outlined in dash lines, is attached to the underside surface of flap 5. The pad may be a soft cotton material of the kind employed in “Band Aid” brand adhesive bandages, which is both absorbent and soft, or it may be constructed of felt, a sponge, a plurality of short toothbrush-like bristles or other similar material.

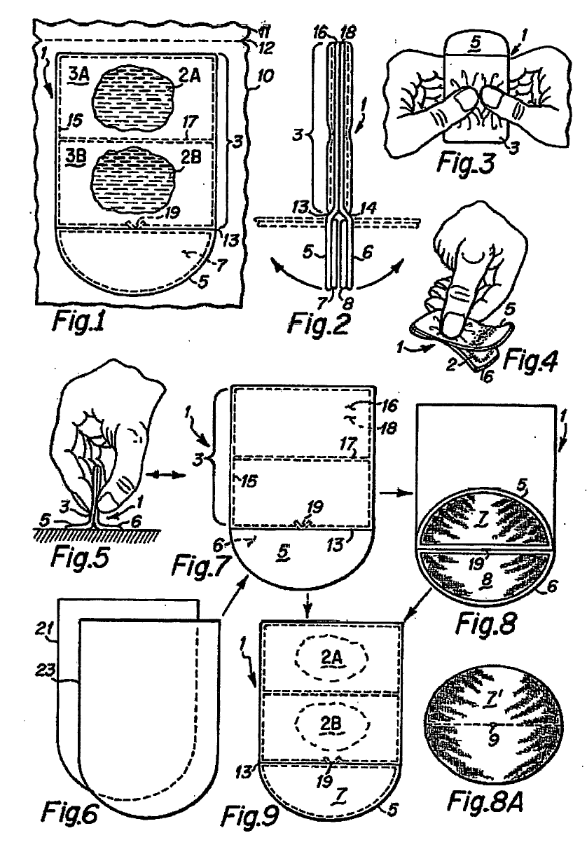

The opposite or rear side of the package is a mirror image of the top side, substantially identical in structure, except that the corresponding pad is located on the upper surface of the flap. Referring to FIG. 2, illustrating package 1 in a not-to-scale side view, it is seen that the package is substantially symmetrical through the center. As better illustrated in this view, container section 3 is formed between a front and rear wall panels 16 and 18, joined together along the edges. As may not be evident from FIG. 2, unfilled, the package would appear flat in side view. However, because the package is illustrated as filled with ingredients 2A and 2B, consistent with FIG. 1, the package expands in thickness. Due to the confined oral care composition, the package front and rear panels, the sides, bulge out sideways.

Also one should note that the package is relatively thin, its thickness being quite small relative to its length and width. That small thickness provides essentially a relatively flat geometry to the package. Such a geometry permits large quantities of packages to be stacked and boxed in quantities of a few dozen for display on store shelves and sale to wholesale and/or retail customers.

As shown in the figure, a second flap 6 is located underlying flap 5. A fold line 14 is located between the flap 6 and the container section. The second flap also includes an absorbent pad 8 of like construction to pad 7, which pad 8 confronts.

Container section 3 and the flaps 5 and 6 in this embodiment are suitably formed from two webs or, as variously termed, sheets of flexible packaging foil material that are heat sealed together, as hereinafter described in greater detail. Flaps 5 and 6 are formed of an end portion of such sheets that have not been thermo-sealed together, since they are disconnected in use so they may spread apart during use, as represented by the phantom lines in the figure. As later herein described, in other embodiments the flaps may be temporarily joined by a tear-off strip to prevent the flaps from spreading apart prior to use, maintaining a relatively flat geometry for convenient packing of multiple units in a larger box.

Returning to FIG. 1, the two sheets or panels of packaging material are bonded together by heat sealing the thermoplastic material along the outer edge or periphery of the container portion to form a relatively shallow pouch. The heat sealing produces a thermal seam, represented by dash line 15. A compartment divider seal 17, illustrated by double dash lines, extends across opposite portions of thermal seam 15, dividing the container section 3 into separate compartments, and an outlet seal 19 to close the compartment's outlet are also thermally formed.

Thermal seam 15 is quite strong. It is liquid tight and resists cracking or breaking even under extreme pressures. It cannot be broken in ordinary use even if pressed by hand against a hard surface. It cannot be broken even by pulling flaps 5 and 6 apart with excessive force. Persons who have used flat packages for dispensing mustard and other condiments should be familiar with the strength of the bond. The foregoing thermal seam extends almost entirely around the periphery of the compartment portion 3, leaving a small passage or opening at the center of the lower end in the figure. The passage is the outlet to the container. The width of that outlet passage is less than the width of the container section 3, typically a fraction of the container's width, such as no greater than one-half that width, although the exact width chosen for any practical embodiment may depend on the physical characteristics of the oral care composition. As example, mouthwash, having low viscosity, requires only a tiny hole, while a dentifrice, being of greater viscosity, requires a relatively larger one.

The small passage in thermal seam 15 is optionally closed by exit seal 19, a conventional frangible seal that appears in the shape of a chevron. Unlike thermal seam 15, which is almost impossible to break by hand, this chevron seal is easily broken. The inter-compartment seal 17 is not quite so strong as the exit seal 19, as it is necessary to break this seal first in order to allow mixing of two ingredients before dispensing the mixture, if desired.

Pads 7 and 8 are preferably included for those applications in which the package is intended to hold a liquid very low in viscosity and freely flowing. In such an application, the container outlet should be very small in diameter, almost a pin-hole, allowing the liquid to be squirted out somewhat, instead of freely running off. When the container is opened, the liquid expressed from the container region will be at least be partially absorbed by the pad; and the liquid is spread on the temporary and natural surfaces of the oral cavity from the pad by rubbing the spread applicator pads against those surfaces.

Reference is again made to FIG. 1. To ensure sterility and/or as an additional safeguard against unintended or accidental leakage and/or to preclude the flaps from spreading apart prior to use, as an additional feature the foregoing package 1 is sealed within a plastic or Cellophane wrapper 10, which forms a shallow relatively flat bag. The wrapper includes a tear-off strip end 11, formed by spaced cuts there through along dash line 12. Apart from its use in the described combination, plastic wrappers of the foregoing type and the use thereof in automatic packaging machinery are well known in the packaging art and need not be described further. When ready to use the packaged ingredients, the tear strip is removed and the container/applicator package is withdrawn from the wrapper.

The principal body of the package applicator is formed of familiar packaging flexible metal foil material, typically a laminate of metal foil and plastic, as later herein discussed in greater detail. The package walls are thin and flexible and may be easily temporarily deformed when filled with fluid by squeezing the sides of the container section between one's finger and thumb.

For use, removed from external package 10, squeezing the sides of package 1 between the thumb and forefinger of each hand, as represented in FIG. 3, temporarily deforms the flexible walls and applies sufficient pressure on the oral care composition to cause same to fracture the optional inter-compartment divider seal 17, and permit the separate contents to mix prior to application if necessary. By squeezing or kneading the sides of the package further, the ingredients may be thoroughly mixed. Should a wall of the container section be transparent, one might include coloring material in the ingredients to provide a visual indication through the sides of the package of the completeness of the mixture.

Following such optional mixing, squeezing the package with greater force should force the oral care composition to burst open chevron seal 19 to thereby open the outlet passage and permit the contents to be expressed from the package, such as partially represented in FIG. 4. Suitably, by squeezing the sides of the package between one's thumb and fingers to flex the package walls together reduces the size of the internal cavity and subjects the contents to a high enough pressure sufficient to cause the confined material 2 to burst or otherwise break dispenser seal 19, which thereby opens the container's dispensing outlet.

Assuming the viscosity of the ingredients is great enough, the dispensed ingredient causes the flaps 5 and 6 to pivot in opposite directions spreading them somewhat apart. Holding the container section 3 with ones fingers, the user may then press the ingredient against the desired surface, spreading the flaps further apart and applying the ingredient to the temporary and permanent oral surfaces, such as represented in FIG. 5. As shown, the length of the flaps and their width is great enough to service this applicator function. The user may then move the spread flaps back and forth and/or up and down along the surface, spreading the oral care composition about said surfaces.

As those skilled in the art appreciate, the invention may be produced using existing flexible packaging materials and assembly processes for the most part. It should be appreciated that the foregoing embodiment and the subsequent embodiments herein as well can be fabricated by hand, given the materials and a hand held heat bar, such as a hot iron. However, automated machine assembly is preferred for high volume manufacture.

Reference is made to FIGS. 6 through 9 which assist in the description of the package of FIG. 1. Two webs of packaging film material 21 and 23 are dispensed in overlaying relationship by automatic machinery from a pair of rolls are cut to the desired shape as represented in FIG. 6. The two webs are then heat sealed to simultaneously form the outer thermal seal 15, the optional divider thermal seal 17 and the chevron exit thermal seal 19, as represented in FIG. 7, which is suitably accomplished using conventional heat sealing apparatus. The two webs are thereby transformed into the container section 3, formed between panels 16 and 18, that optionally contains separate internal compartments 3A and 3B, and appended integral end flaps 5 and 6, the latter flap not being visible in this figure. Where a fold line 13 is to be included between the container section and flaps, that is also accomplished with the heat sealing machinery by pressing a straight bar into the material to form a permanent groove.

In the next step of the fabrication process, as illustrated in FIG. 8, one flap 5 is flipped over, exposing the inside surface of both flaps 5 and 6. The absorbent pads 7 and 8 are adhesively affixed to the respective flaps, suitably with thermosetting adhesive. Then flap 5 is flipped or rotated back to its normal position as in FIG. 9.

Alternatively, at the step represented in FIG. 8 a single larger absorbent pad 7′ may be substituted for pads 7 and 8 that is large enough to cover substantially the inner surface of both flaps and contains a central aperture 9. positioned to align with the container's dispensing outlet at chevron 19. Such a unitary pad would be adhesively fastened to both flaps, bridging the space between those flaps, and would fold in half.

The one or, optionally, two compartments are then filled with the oral care compositions 2A and, optionally, 2B, using a conventional needle filler. As is known, the filling of flat packages with condiments and other fluid ingredients is often accomplished with a hollow needle. The needle punctures a hole through the side of the packaging material and dispenses the fluid through the needle into the formed internal cavity. Upon withdrawing the needle, the filling machinery seals up the small puncture by heat sealing. That machinery is well known in the packaging art and need not be described further.

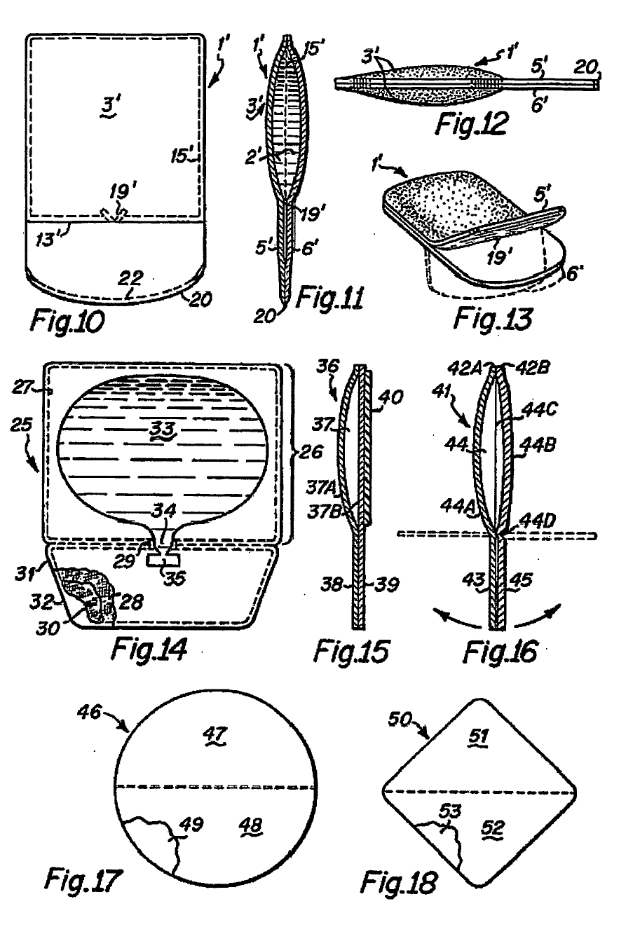

Reference is made to FIG. 10 which illustrates a second embodiment of the package suitable for use in the methods of the present invention. For convenience, the same number used to identify elements of the prior embodiment is used for like elements appearing in this embodiment, but with those numbers primed. In this, package 1′ contains only a single compartment 3′. Like the embodiment of FIG. 1, the unit is formed of two substantially identical sheets of plasticized metal foil laminate superimposed over one another and joined together by thermal seams. Applied by standard thermo seal technique, thermal seam 15′, extends about the compartment section 3′, interrupted in that path by a thermal seal, chevron seal 19′, a frangible closure or seal, as variously termed, located at a midpoint of one end of the unit. The chevron seal closes the opening in thermal seam 15′ that serves as the dispensing outlet. Thermal seam 15′ extends from the rear end of the unit and extends along the side for about eighty percent of the length of the unit and then turns in direction, leaving the remaining end portion of the foil laminate's length unsealed and free to flap.

The unit contains a fold line 13′ formed in the sheet material, and a like fold line on the other sheet, not visible in this view. The fold lines assist the flaps to more easily swung around. However, as in the prior embodiment, in alternative embodiments of the invention the fold line may be omitted if desired. Generally speaking, where the material selected is sufficiently pliant, it is possible to pivot or arcuately spread apart the flaps over a wide arc without the inclusion and assistance of a fold line. Where, however, the material selected for the combination is thicker and, hence, of greater stiffness, then inclusion of a fold line is desirable.

The outer end of the two flaps in this embodiment, flap 5′ and the underlying flap 6′ visible in FIG. 11, are held together by a tear seal strip 20. The tear strip retains the flaps in place, essentially extending straight and in parallel, for more convenient packaging of such units, as filled with product, in multiple quantities in a box. The strip is formed integrally in the sheet material at the end of the flaps, by adhesively or thermally joining a narrow edge portion of the flap ends together and incorporating a familiar tear line 22 in the end of the flaps. The user simply tears off strip 20 to disconnect the flaps from one another, which permits the flaps to pivot about their respective fold lines independently of one another.

FIG. 11 illustrates the embodiment of FIG. 10 in section view. Flaps 5′ and 6′ extend essentially in parallel, but are connected together at the distal end by tear off tab 20. The proximal end of each flap is integral with the end of container section 3′. Thermal seam 15′, that extends about the periphery of the container section connecting together the edges of the front and back panels and defines the container's internal cavity, is partially visible in the figure. The container section is illustrated as filled with an ingredient 2′.

As illustrated in side view in FIG. 12, the sides of the container section 3′ bulge outwardly, since the unit is illustrated as filled with an oral care composition. With the tear off tab 20 removed, flaps 5′ and 6′ can be manually spread apart as illustrated in partial perspective in FIG. 13. The frangible chevron seal 19′, which closes the passage into the container, is indicated as being centrally positioned. As indicated by the dash line, flap 6′ may pivot downwardly even further, should the packaging material used have a greater degree of pliancy or flexibility.

As in the prior embodiment, chevron seal 19′ may be fractured by pressing the sides of the package together, to burst the seal and express the oral care composition through the open outlet. Alternatively, with a slight change in positioning of the chevron seal, the chevron outlet seal may be broken, torn apart, when the flaps are manually spread apart. By having chevron 19′ extend a small amount into the region occupied by the flaps, a front portion of the chevron is then thermally formed between the two flaps. As that chevron seal is relatively weak, intentionally made frangible, when the flaps are pulled apart, that pulling force detaches that portion of the seal, thereby opening the outlet. As earlier noted, although the flaps are pulled apart, the package remains intact since it is not reasonably possible to tear the package apart by using excess pull on the flaps due to the strength of the thermal seams.

The foregoing embodiment of FIGS. 10 through 13 is preferably fabricated using the same techniques illustrated and described in connection with FIGS. 6 through 9, excepting that the step of attaching the absorbent pads, represented in FIG. 8 is by-passed; and the steps of forming the tear strip 20 are included in the step represented by FIG. 7. When opened it is used in the same manner as described for the prior embodiment.

Although the container outlet passage and the chevron seal 19′ to the container are centrally positioned in these and the subsequent embodiments, those skilled in the art appreciate that those elements may alliteratively be positioned at other less preferred locations along the container's end, without departing from the scope of the present invention. The illustrated positioning ensures that there is less likelihood that the dispensed ingredient will in small part fall off a side edge of the flap.

Further, it is appreciated that the axis of the outlet passage in the foregoing and in the succeeding embodiments is preferably straight and coaxial with the principal axis of the container. In that way when the ingredients are expressed under pressure from the container, the ingredient flow should predominantly be toward the front of the unit. However, as those skilled in the art appreciate, the passage axis may be oriented in other directions in alternate embodiments without departing from the scope of the invention, as example, should one prefer the ingredient flow to be toward one side or other of the flap.

Reference is next made to FIG. 14, which illustrates still another embodiment of the package suitable for use in the present methods. Like the single compartment embodiment of FIG. 10, the container applicator 25 is formed of two substantially identical sheets of plasticized metal foil laminate superimposed over one another and joined together by thermal seams. Applied by standard thermo seal technique, thermal seam 27, extends about the compartment section 26 of the unit, interrupted in that path by a small outlet or passage 29, located at a midpoint of one end of the unit. Thermal seam 27 extends from the rear end of the unit and extends along side for about eighty percent of the length of the unit, leaving the remaining end portion unsealed and free to flap, defining, as in the case of the prior embodiments, an upper flap 31, and a lower flap 32, only partially visible in this figure in the cut-out section to the lower left, underlying flap 31.

Each flap includes an absorbent pad 28 and 30, respectively, the latter pad being partially illustrated in the partial cut-out section to the lower left. That pads are attached to the inside surface of the flaps, as in the embodiment of FIG. 1, so that the pads face one another. Alternatively, it is appreciated that a single larger pad containing a central aperture, such as was described in connection with a prior embodiment, may be substituted for the two pads.

A relatively shallow sac or bladder or bag 33, as variously termed, is located within compartment section 26's internal region defined between the two foil laminate sheets. Bag 33 is formed in the same manner as the other portion of the unit, that is, by heat sealing the peripheral edge together to form a closed compartment. Further, the bag is filled with the intended ingredient prior to heat sealing the outer sheets together. Bag 33 contains a small neck 34, which serves as the bag's outlet. The neck extends through passage 29 and protrudes into the region of the confronting flaps 31. The neck is closed at the end by a frangible seal, particularly a tear tab 35.

In this embodiment, although the two sheets of flexible foil material are fused together to define an internal compartment, that compartment need not be liquid tight. The internal compartment subsumes another container, which is liquid tight.

For use, the user spreads the confronting flaps aside and accesses and removes the tear tab 34, opening the sack 33. Then, pressing the sides of the container with the fingers (as in FIG. 4), the oral composition is expressed from the sack 33 onto the pads 28 and 30, spreading the respective associated flaps 31 and 32 apart. The user then grips the sides of the container and applies the composition to the temporary and permanent oral surfaces, as earlier represented in FIG. 5, and spreads the composition about the surface with the spread out pads.

The foregoing construction is more expensive to produce than the embodiments of FIGS. 1 and 3, and thus is preferred for applications that require the particular construction. As example, the lowest cost approach is to use the existing flexible foil laminate materials currently used in micro-sized packages. However, should one find that a particular oral care composition adversely reacts with that material, rather than discarding use of the packaging material, one may find it more economical to house the material in a separate bag that is of a non-reactive material, which the described embodiment permits.

Upon reading the foregoing description of the preferred embodiments of the invention those skilled in the art should call to mind additional embodiments which are less preferred because they are of a more expensive construction or do not have all of the advantages and features of the foregoing embodiments, all of which come within the scope of the present invention.

As example, some may desire the package for use in the methods of the present invention to have a more rigid applicator handle than the foregoing construction provides. To satisfy such an application, the foregoing structure may be modified to incorporate a more stiff characteristic on at least one side. Reference is made to FIG. 15 which shows in section an alternative embodiment containing a more firm handle applicator. As shown, the container applicator 36 contains a container section defining an internal cavity 37 formed between the two sheets 37A and 37B of flexible foil material thermo-sealed together with thermal seams and containing a chevron outlet seal, just as in the embodiment of FIG. 10, earlier described. It contains the two parallel extending applicator flaps 38 and 39 at one end. As in the case of the prior embodiments the container section includes the container outlet and the frangible chevron seal closure for that outlet, too small in size to be visible in the figure, and leads to the region between the spreadable flaps 38 and 39.

In this section view, for purposes of illustration, the one sheet to the left is shown bulging outwardly, as would be the situation in which the container is filled with an oral care composition. However, the reader is reminded that the left sheet would be laying against the other sheet, prior to filling the internal cavity 37 with the packaged ingredient. In top view the embodiment should appear the same as the embodiment of FIG. 10.

A relatively thick layer or panel 40 is bonded to the right wall 37B. The panel may comprise a thick layer of thermoplastic material, perhaps two to five times greater in thickness than wall 37B. The panel is bonded to that wall thermally or with an adhesive.

In this embodiment, the frangible closure member is broken, as in most of the described embodiments, by pressing the sides of the container section between ones thumb and finger. However, in this construction, only the one wall 37A would flex, the stiffened wall serving somewhat as an anvil. The stored oral care composition would then be expressed from the container section into the region between the spreadable flaps by continued finger pressing the side walls.

In addition to the panel stiffener, the handle can be constructed to be more stiff in a more economical way. Reference is made to FIG. 16, which shows in section another alternative embodiment containing a more firm applicator handle. As shown, the container applicator 41 contains a container section defining an internal cavity 44 formed between the two sheets 44A and 44B of flexible foil material thermo-sealed together with thermal seams and containing a chevron outlet seal, just as in the embodiment of FIG. 10, earlier described. And it contains the two parallel extending applicator flaps 43 and 45 at one end. As in the case of the prior embodiments the container section includes the container outlet and the frangible chevron seal closure for that outlet, too small in size to be visible in the figure, and leads to the region between the spreadable flaps 43 and 45. The portion of the thermal seam 44c extending alongside the left side of the container section is visible in this view.

In this section view, again for purposes of illustration, the one foil sheet to the left 44A is shown bulging outwardly, as would be the situation in which the container is filled with an oral care composition. However, the reader is again reminded that the left sheet 44A would be laying against the other sheet 44B, prior to filling the internal cavity 44 with the oral care composition. And in top view this embodiment should appear the same as the embodiment of FIG. 10.

As illustrated the one wall to the right 44B and the flap 45 are formed from a foil sheet laminate that is of greater thickness, suitably, three to five times as thick, and, hence, is more stiff in physical characteristic than the foil sheet laminate to the left. The increased wall thickness to the one side of the container section is thus less pliable or flexible than the other side, and, in that respect, essentially emulates the stiffening panel 40 of the prior embodiment.

As a consequence of the foregoing construction, flap 45 is substantially more thick than flap 43. A fold line 44D is included to assist in pivotal movement of flap 45, such as to a position indicated by the phantom lines to the right. Due to the greater thickness, it is more difficult to pivot the flap 45 without the fold line, whereas a fold line might not be required for flap 43. Although the flaps are not identical in thickness, that should not hinder the operation of the applicator.

In this embodiment, the frangible closure member is broken, as in the prior embodiments, by pressing the sides of the container section between ones thumb and finger. However, in this construction, the one wall 44A would flex to a greater extent than wall 44B, the stiffened wall serving somewhat as an anvil. The stored spreadable ingredient would then be expressed from the container section and into the region between flaps 43 and 45 by continued finger pressing the side walls

The foregoing embodiments are recognized as being rectangular in surface geometry, both wide and narrow in alternative versions and with flap geometries that were either rectangular with rounded corners or almost semicircular in geometry. As those skilled in the art appreciate, the invention may be fabricated in other geometries without departing from the scope of the present invention. As example, additional geometries for the described combination are pictorially illustrated in FIGS. 17 through 18. As shown in FIG. 17 in container applicator 46 both the container 47 and the wings 48, 49 may be semicircular in top surface geometry with the combination appearing as a circle. In the container applicator combination 50 FIG. 18 the container portion 51 and wings 52, 53 are of a quasi-diamond shape, the wings containing a rounded exterior point.

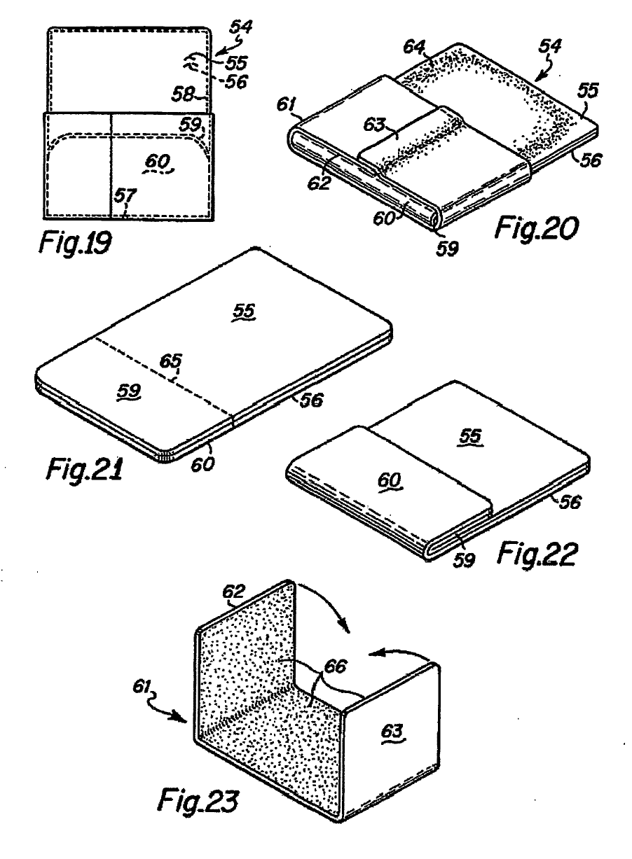

Reference is next made to FIG. 19, which pictorially illustrates still another embodiment of the invention 54. As in the prior embodiments the package is formed between two panels containing flexible thermoplastic material, 55 and 56, which, except for an outlet 57, are thermosealed together in overlying relationship along the outer edges by a thermal seam, as represented by the dotted line 58, to form an internal package compartment, with a pair of forwardly extending applicator flaps 59 and 60, each of which is formed integral with a respective one of panels 55 and 56. In this applicator package, a small void 57 in the thermal seam at the dispensing end of the package is centrally located in that wall between the flaps and serves as the outlet for the packaged ingredients. Unique to this embodiment, flaps 59 and 60, represented in invisible lines, are folded over one another and pressed onto the top of one of the package panels 55, thereby blocking outlet 57.

Just as in the prior embodiments, the inner surfaces of the flaps 59 and 60 may contain an absorbent pad, or like material. However, to simplify this description, the absorbent pads are not illustrated in this embodiment.

An adhesively coated tape 61 is wrapped about the dispensing end of the package, extending laterally across the width, and secures flaps 59 and 60 against panel 55. The tape is of a length, relative to the width of the package, so as to permit one end of the tape, located on tape flap 63, to overlap the other end, located on tape flap 62, when fixed in place. The tape's width is slightly greater than the length of applicator flaps 59 and 60 to permit a side end of the tape to attach directly to a portion of the underlying panel 55 as well as to the surface of the underlying applicator flap 60.

The tape adhesive is such as to provide an adequate protective seal to protect dispensing outlet 57 and, together with the folded over flaps 59 and 60, ensure the outlet remains closed; yet provides an adhesive strength or bond that is sufficiently weak to enable a normal user to easily peel away the tape to release the confined ingredients from the package. Adhesives of that kind are used in the familiar “Post-It.®” notes.

As shown in the perspective view of FIG. 20, an end edge of the overlying end 63 of tape 61 may be left free of adhesive so that it uplifts slightly to offer the user a surface to easily grip the tape and pull it free of the package. As illustrated in this perspective view the package is shown to bulge slightly at 64, to accommodate the ingredient represented as being confined in the package. If desired the tape may be constructed even wider than that illustrated to also cover even the exposed fold at the attached end of flap 60 shown in the figure, creating an overhang in the tape at that end, and those overhanging edge portions of the tape may be sealed to one another.

The foregoing embodiment is easily manufactured. FIG. 21, shows the package in the stage of assembly with two panels 55 and 56 attached in overlying relationship and the forwardly extended integral applicator flaps 59 and 60, attained through the procedure earlier described in connection with FIGS. 6-9 for a preceding embodiment. The left and right sides are attached along their edges with the thermal seam, the panels front edges are similarly thermally attached along the base of flaps 59 and 60, excepting the small gap therein forming outlet 57, earlier described and not visible in the figure, the fold lines 65, if included, are formed at the base of the flaps, and absorbent pads, if included, are installed on the inner confronting faces of the flaps. At this stage the rear edges of panels 55 and 56 remain unsealed to permit the oral care compositions to be inserted at a later stage of manufacture, as was the situation with the preceding embodiments.

Next, as illustrated in FIG. 22, both flaps 59 and 60 are folded over on top of one of the two panels. The fold in the panel covers or blocks outlet 57. Then tape 61, the inner surface of which is coated with adhesive 66, is folded to form two vertically oriented flaps 62 and 63, as represented in FIG. 23. With the one edge of the tape aligned with the forward edge of the formed package shown in the figure, the horizontal portion of tape 61 is then pressed against the surface the lower panel 56. Tape flap 62 is then folded over onto the outer surface of the lower applicator flap 60 and to a portion of the surface of the upper package panel 55 to all of which the tape flap adheres. The other tape flap 63 is in turn folded over onto another portion of the outer surface of the lower flap 60, to another portion of the surface of the upper package panel 55, and over a portion of tape flap 62 to all of which the tape flap adheres. This effectively seals the dispensing end of the applicator package.

A dose of the fluid oral care composition that is to be packaged in the applicator package, is squirted into the yet unsealed bottom end. The bottom end is then thermally sealed, and completes the filled applicator package earlier illustrated in FIG. 20 to which reference is again made.

When the user wishes to dispense and spread the oral care composition from this applicator package embodiment, the user pulls up on tape flap 63 and pulls the entire tape away from the other elements. The pull on the tape also assists to pull at least the lower flap 60 away from its position atop the upper flap 59 and, ideally, due to friction, both flaps move to the forward extended and spread position. Alternatively, the user can move both flaps to a forward and spread position with the user's fingers. The dispensing outlet is thereby uncovered and is open.

At this juncture, the embodiment functions much like the preceding embodiments. By pressing the sides of the package with ones fingers, the user expresses a portion of the oral care composition from the package onto the desired flaps or surface. With the flaps spread apart, the composition may be easily spread about the oral surfaces.

The foregoing embodiments of a package suitable for use in the methods of the present invention use the same metal foil laminates, typically aluminum foil, found in existing flexible packages. Those skilled in the packaging art recognize the available metal foil laminates, including, by trade identification, Seal-foil 101, which is a metallized polyester or EVA; Seal-foil 102 which is a metalized polyester/polyester gold laminate; Seal-foil 122 is white kraft/metal foil/polyester laminate; Seal-foil 125 ms is a brown/kraft/metal foil/polyester laminate; and Seal-foil 360 is a Nylon/poly/metal foil/poly in successive layers Kraft, metal foil, poly, polypropylene, clear, poly, and meal foil. Preferably a practical form of the foregoing embodiments is constructed from the Seal-foil 360 film laminate.

The foil laminate used for the construction must be one approved for use with oral compositions and one which does not adversely react with the stored oral care composition, or become corroded therefrom.

The surface area defined by the top and bottom sides of the container section of the package applicator combination at a minimum should be of a size that accommodates at least one average thumb size of persons, as that information may be tabulated by the medical authorities, and perhaps be as large as that thumb size as would be expected to be the largest person one would expect to encounter in society. Thus, package embodiments including flaps are anticipated to be between ½ by 1 inch to 6 by 6 inches or larger in size. The container portion of the package should be sized to contain a unit dose of the oral care composition to be used.

In the foregoing embodiments the sides of the container applicators are illustrated as transparent or plain in appearance. However, the practical embodiments of the invention are expected to contain advertising material, brand identification and other printed information and coloring as presently exists for micro-packages.

The size of the container's outlet may be varied depending upon the viscosity of the confined spreadable material and the amount of finger pressure desired to express the ingredient. For a given finger pressure with high viscosity fluids, such as a dentifrice, the closure passage can be quite large; for low viscosity fluids, such as mouthwash, the passage can be minute.

It is understood that oral care compositions are liquids and semi-fluids in any viscosity, high or low, sols and gels and/or pastes. Any oral care composition may be used in the present invention. Such compositions include, but are not limited to, mouthwashes, mouthrinses, toothpastes, tooth gels, oral gels, tooth whitening gels, denture cleansers, denture adhesives and any other compositions suitable for use upon the permanent and temporary surfaces of the oral cavity. The oral care compositions for use in the present invention may include any cosmetic or therapeutic actives, alone or formulated with one or more diluents, excipients, and/or vehicles and carriers that are known in the art. Suitable cosmetic or therapeutic actives include any material that is generally considered safe for use in the oral cavity and that provides changes to the overall appearance and/or health of the oral cavity. The cosmetic and therapeutic actives may be selected from the group consisting of anti-calculus agents; breath fresheners; anti-caries agents such as fluoride ion and stannous ion sources; whitening agents; anti-microbial agents; anti-plaque agents; anti-inflammatory agents; anti-bacterial agents; tooth desensitizing agents; nutrients; antioxidants; antiviral agents; disinfectants; anti-fungal agents; analgesic agents; anesthetic agents; H-2 antagonists; fragrances; sensates; pigments; dyes; lakes; colorants; and mixtures thereof.

As used herein, the term “temporary and permanent surfaces of the oral cavity” include surfaces of natural teeth, dentures, bridges, partials, dental work, braces, retainers, any other dental prosthesis that is fixed or removable from the oral cavity, gums, tongue surfaces, and any other mucosal surface within the oral cavity.

The methods of the present invention can be performed in the mouth or, alternatively outside the mouth when the surfaces to receive the oral care composition are removable from the mouth, such as dentures or a retainer.

### EXAMPLES

Examples of oral care compositions suitable for use in the methods of the present invention follow:

| | Dentifrice Examples | | | |
|---|---|---|---|---|
| | Dentifrice | Dentifrice | Dentifrice | Dentifrice |
| | Example A | Example B | Example C | Example D |
| Water | 36 | 36 | 32 | 16.804 |
| Hydrated Silica | 23 | 23 | | 13 |
| Calcium carbonate | | | | 17.76 |
| Dicalcium Phosphate Dihydrate | | 40 | | |
| Sodium bicarbonate | | | | 2 |
| TSPP | | | 0.5 | |
| Sorbitol | 28 | 28 | 20.24 | 43 |
| Glycerin | 4.757 | 5 | | |
| PEG-6 | 3 | 3 | 3 | 3 |
| Sodium Lauryl Sulfate | 1.5 | 1.5 | 1.2 | 1.2 |
| Flavor | 1 | 1 | | |
| Titanium Dioxide | 1 | 1 | 1 | 1 |
| Carrageenan | 0.8 | 0.8 | 0.5 | 0.1 |
| Xanthan | 0.4 | 0.4 | | |
| Cellulose | | | 0.5 | 1 |
| Sodium Fluoride | 0.243 | 0 | | |
| Na Monofluorophosphate | | | 0.76 | 0.836 |
| Sodium Saccharin | 0.3 | 0.3 | 0.3 | 0.3 |
| Preservative | | | | 0.5 |
| Total | 100 | 100 | 100 | 100 |

| | | | | Whitening | Whitening | Whitening | Local |
|---|---|---|---|---|---|---|---|
| Mouthrinse, | Rinse | Rinse | Gel | Gel | Gel | Gel | Anesthetic |
| Gel Examples | Ex. E | Ex. F | Ex. G | Ex. H | Ex. I | Ex. J | Ex. K |
| Water | 80.941 | 93.05 | 64.3 | | | 31.94 | 0.8 |
| Ethanol | | | | | | 20 | 48 |
| Sodium bicarbonate | | 1 | | | | | |
| Glycerin | 0 | | 5 | 81.76 | 87.76 | 20 | |
| Propylene Glycol | | | | 0.25 | | | 20.00 |
| PEG-2000 | | | | | | 5 | |
| PEG-60 Hydrogenated | 4.379 | 5 | | | | | |
| Castor Oil | | | | | | | |
| Cocamidopropyl betaine | | 0.1 | | | | | |
| Cetyl pyridinium | | 0.1 | | | | | |
| chloride | | | | | | | |
| Sodium Lauryl | | | | 0.45 | | | |
| Sarcosinate | | | | | | | |
| Pluronic | | | 20 | | | | |
| Flavor | 0.4 | 0.4 | 0.4 | 0.1 | 0.05 | | 0.2 |
| Ethyl Cellulose | | | | | | | 5 |
| Carbopol | | | | | 0.65 | 5 | |
| Sodium Fluoride | 0.221 | 0.05 | | | | | |
| NaH2PO4-H20 | 3.638 | | | | | | |
| Phosphoric Acid NF | | | | | 0.08 | | |
| Sodium Polyphosphate | 0.221 | | | | | | |
| Benzalkonium Chloride | 0.1 | | | | | | |
| Sodium Saccharin | 0.1 | 0.3 | 0.3 | | | | |
| Xylitol | 10 | | 10 | | | | |
| Triethanol Amine | | | | | 0.26 | | |
| Urea | | | | 6.82 | 11.2 | | |
| Citric Acid - hydrous | | | | 0.06 | | 0.06 | |
| Tannic acid | | | | | | | 4 |
| Salicylic acid | | | | | | | 2 |
| Benzocaine | | | | | | | 20 |
| Carbamide Peroxide | | | | | | 18 | |
| H2O2 (30%) | | | | 10.56 | | | |
| Total | 100 | 100 | 100 | 100 | 100 | 100 | 100 |

| Denture Cleanser | |
|---|---|
| Example | Ex. L |
| Calcium Peroxide | 0.5 |
| water | 12 |
| glycerin | 21 |
| propylene glycol | 27 |
| sodium | 0.4 |
| monofluorophosphate | |
| sodium bicarbonate | 5 |
| silicon dioxide | 2 |
| sodium saccharin | 0.3 |
| titanium dioxide | 1 |
| hydrated silica | 17 |
| PEG 600 | 10 |
| Carboxymethyl cellulose | 0.6 |
| SLS | 2 |
| Flavor | 1.2 |
| Total | 100 |

| Denture Adhesive | |
|---|---|
| Example | Ex. M |
| Mineral Oil, heavy | 16 |
| petrolatum | 27.85 |
| fumed silica | 0.5 |
| mixed Mg/Zn/Na salt of | 29.45 |
| poly(VME/MA) | |
| Spray dried peppermint | 0.8 |
| Red No. 7 Lake | 0.02 |
| Na CMC | 23.55 |
| Spray dried spearmint | 0.8 |
| Red No. 30 Lake | 0.03 |
| Carbopol 974P | 1 |
| Total | 100 |

| Desensitizing | |
|---|---|
| Toothpaste Example | Ex. N |
| Potassium nitrate | 5 |
| Sodium saccharin | 0.35 |
| Sodium fluoride | 0.243 |
| sodium bicarbonate | 25 |
| Hydrated silica | 10 |
| Titanium dioxide | 0.5 |
| Fumed silica | 1 |
| Humectant | 24 |
| Hydroxyethylcellulose | 1.2 |
| Sodium lauryl sulfate | 1.5 |
| Flavor | 1.3 |
| Preservatives | 0.1 |
| Water | 29.807 |
| Total | 100 |

What is claimed is:

1. A method of applying an oral composition to any of the temporary and permanent surfaces of the oral cavity comprising the step of;
a.) obtaining a container and applicator combination formed as an assembly that comprises a container comprising an internal region containing an oral care composition and an applicator comprising a pair of spreadable wings;
b.) expelling said oral care composition from said internal region; and
c.) spreading said oral care composition onto the surfaces of the oral cavity with said spreadable wings.

2. The method of claim 1 wherein said container and applicator combination comprises: a pair of flexible foil sheets of substantially identical structure superimposed over one another and permanently fastened together to define there between said container and an outlet to said container from which to express said oral care composition; and wherein said applicator comprises a pair of arcuately spreadable wings for spreading said oral composition onto the surfaces of the oral cavity.

3. The method of claim 1 wherein said container comprises top and bottom surfaces and first and second ends; said top and bottom surfaces having a length and width dimension defining a surface area sufficient in size to receive at least the thumb of a hand, whereby said container may be gripped between the thumb and finger of a hand; and said length and width dimension being substantially greater than the thickness dimension between said top and bottom surfaces to define a relatively thin appearance; said container including a dispensing outlet located at said second end; and an applicator, said applicator being integrally attached to said container to define therewith a unitary one-piece structure; said applicator comprising: first and second wings, each of said wings being integrally attached to and extending outwardly from said second end of said container and being capable of being spread apart pivotally in opposite directions over a wide arc; said first wing being located to one side of said dispensing outlet and said second wing being located to an opposite side of said dispensing outlet; and said first wing defining an applicator surface on an underside surface thereof and said second wing defining an applicator surface on an upperside surface thereof.

4. The method of claim 3, wherein at least one of said flaps of said pair includes on an inner side surface thereof an absorbent pad.

5. The method of claim 3 wherein said container and applicator combination further comprising a pad attached to said underside surface of said first and second wings, said pad including a small passage there through adjacent said dispensing outlet.

6. The method of claim 1 wherein the container and applicator combination comprises: a pair of flexible sheets, said flexible sheets being connected together to define therebetween a container for confining an oral care composition and an applicator; said applicator comprising a pair of end flaps, one of said flaps integrally formed in an end of one of said flexible sheets in said pair and the other of said flaps being integrally formed in the corresponding end of the other one of said flexible sheets in said pair, and said flaps being positioned in overlying relationship; and a frangible closure integrally formed between said pair of sheets, said closure being normally closed and providing, when open, a passage from said cavity region to said flaps through which said oral care composition may be expressed into at least the region between said flaps, whereby sufficient finger pressure exerted to press said flexible sheets toward one another increases pressure on said confined oral care composition sufficient to express said oral care composition from said cavity region through said passage and into contact with said flaps.

7. The method of claim 6 wherein at least one of said flaps of said pair includes on an inner side surface thereof an absorbent pad.

8. The method of claim 6 wherein said container and applicator combination further comprises: an absorbent pad; said absorbent pad being attached to an inner side surface of each of said flaps and bridging the space there between; said absorbent pad including a small central opening.

9. The method of claim 1 wherein the integral package and applicator combination comprises:
a relatively flat container having a pair of walls, at least one of said walls of said pair being resilient and said walls being of an area sufficient to permit said container to be gripped and squeezed between the thumb and fingers of one hand; said flat container including an outlet, said outlet being located at an end of said relatively flat container; first and second flaps; said flaps being of a width less than the width of said end of said relatively flat container and said flaps being integrally attached to said end of said container; said first flap being attached to said container at a position above said outlet for swinging movement in one direction and a second one of said flaps being attached to said container at a position below said outlet, in confronting relationship to said first flap, for swinging movement in a second direction opposite to said first direction, whereby said flaps may spread apart to define an applicator and wherein said flat container serves as a handle to said applicator.

10. The method of claim 9 wherein at least one of said flaps of said pair includes on an inner side surface thereof an absorbent pad.

11. The method of claim 9 wherein said container and applicator combination further comprises an absorbent pad; said absorbent pad being secured to the inner surface of each of said flaps whereby said absorbent pad bridges said flaps; and said absorbent pad further including a small passage there through adjacent said outlet.

12. The method of claim 1 wherein the oral care composition is selected from the group consisting of mouthwashes, mouthrinses, toothpastes, tooth gels, oral gels, tooth whitening gels, denture cleansers and denture adhesives.

13. The method of claim 1 wherein the oral care composition comprises a cosmetic or therapeutic active.

14. The method of claim 13 wherein the cosmetic or therapeutic active is selected from the group consisting of anti-calculus agents; breath fresheners; anti-caries agents such as fluoride ion and stannous ion sources; whitening agents; anti-microbial agents; anti-plaque agents; anti-inflammatory agents; anti-bacterial agents; tooth desensitizing agents; nutrients; antioxidants; antiviral agents; disinfectants; anti-fungal agents; analgesic agents; anesthetic agents; H-2 antagonists; fragrances; sensates; pigments; dyes; lakes; colorants; and mixtures thereof.

15. A method of cleaning any of the temporary and permanent surfaces of the oral cavity comprising the step of;
a.) obtaining a container and applicator combination formed as an assembly that comprises a container comprising an internal region containing an oral care composition and an applicator comprising a pair of spreadable wings;
b.) expelling said oral care composition from said internal region;
c.) spreading said oral care composition onto said surfaces of the oral cavity with said spreadable wings; and
d.) rubbing the oral care composition onto said surfaces of the oral cavity with said speadable wings.

16. The method of claim 15 wherein said container and applicator combination comprises: a pair of flexible foil sheets of substantially identical structure superimposed over one another and permanently fastened together to define there between said container and an outlet to said container from which to express said oral care composition; and wherein said applicator comprises a pair of arcuately spreadable wings for spreading said oral composition onto the surfaces of the oral cavity.

17. The method of claim 15 wherein said container comprises top and bottom surfaces and first and second ends; said top and bottom surfaces having a length and width dimension defining a surface area sufficient in size to receive at least the thumb of a hand, whereby said container may be gripped between the thumb and finger of a hand; and said length and width dimension being substantially greater than the thickness dimension between said top and bottom surfaces to define a relatively thin appearance; said container including a dispensing outlet located at said second end; and an applicator, said applicator being integrally attached to said container to define therewith a unitary one-piece structure; said applicator comprising: first and second wings, each of said wings being integrally attached to and extending outwardly from said second end of said container and being capable of being spread apart pivotally in opposite directions over a wide arc; said first wing being located to one side of said dispensing outlet and said second wing being located to an opposite side of said dispensing outlet; and said first wing defining an applicator surface on an underside surface thereof and said second wing defining an applicator surface on an upperside surface thereof.

18. The method of claim 17 wherein at least one of said flaps of said pair includes on an inner side surface thereof an absorbent pad.

19. The method of claim 17 wherein said container and applicator combination further comprising a pad attached to said underside surface of said first and second wings, said pad including a small passage there through adjacent said dispensing outlet.

20. The method of claim 15 wherein the container and applicator combination comprises: a pair of flexible sheets, said flexible sheets being connected together to define therebetween a container for confining an oral care composition and an applicator; said applicator comprising a pair of end flaps, one of said flaps integrally formed in an end of one of said flexible sheets in said pair and the other of said flaps being integrally formed in the corresponding end of the other one of said flexible sheets in said pair, and said flaps being positioned in overlying relationship; and a frangible closure integrally formed between said pair of sheets, said closure being normally closed and providing, when open, a passage from said cavity region to said flaps through which said oral care composition may be expressed into at least the region between said flaps, whereby sufficient finger pressure exerted to press said flexible sheets toward one another increases pressure on said confined oral care composition sufficient to express said oral care composition from said cavity region through said passage and into contact with said flaps.

21. The method of claim 20 wherein at least one of said flaps of said pair includes on an inner side surface thereof an absorbent pad.

22. The method of claim 20 wherein said container and applicator combination further comprises: an absorbent pad; said absorbent pad being attached to an inner side surface of each of said flaps and bridging the space there between; said absorbent pad including a small central opening.

23. The method of claim 15 wherein the integral package and applicator combination comprises:
a relatively flat container having a pair of walls, at least one of said walls of said pair being resilient and said walls being of an area sufficient to permit said container to be gripped and squeezed between the thumb and fingers of one hand; said flat container including an outlet, said outlet being located at an end of said relatively flat container; first and second flaps; said flaps being of a width less than the width of said end of said relatively flat container and said flaps being integrally attached to said end of said container; said first flap being attached to said container at a position above said outlet for swinging movement in one direction and a second one of said flaps being attached to said container at a position below said outlet, in confronting relationship to said first flap, for swinging movement in a second direction opposite to said first direction, whereby said flaps may spread apart to define an applicator and wherein said flat container serves as a handle to said applicator.

24. The method of claim 23 wherein at least one of said flaps of said pair includes on an inner side surface thereof an absorbent pad.

25. The method of claim 23 wherein said container and applicator combination further comprises an absorbent pad; said absorbent pad being secured to the inner surface of each of said flaps whereby said absorbent pad bridges said flaps; and said absorbent pad further including a small passage there through adjacent said outlet.

26. The method of claim 15 wherein the oral care composition is selected from the group consisting of mouthwashes, mouthrinses, toothpastes, tooth gels, oral gels, tooth whitening gels, denture cleansers and denture adhesives.

27. The method of claim 15 wherein the oral care composition comprises a cosmetic or therapeutic active.

28. The method of claim 27 wherein the cosmetic or therapeutic active is selected from the group consisting of anti-calculus agents; breath fresheners; anti-caries agents such as fluoride ion and stannous ion sources; whitening agents; anti-microbial agents; anti-plaque agents; anti-inflammatory agents; anti-bacterial agents; tooth desensitizing agents; nutrients; antioxidants; antiviral agents; disinfectants; anti-fungal agents; analgesic agents; anesthetic agents; H-2 antagonists; fragrances; sensates;
pigments; dyes; lakes; colorants; and mixtures thereof.

29. An oral treatment kit comprising:
a.) container and applicator combination formed as an assembly that comprises a container comprising an internal region and an applicator comprising a pair of spreadable wings;
b.) an oral composition within the container; and
c.) instructions for use.

30. The oral treatment kit of claim 29 wherein the oral composition is selected from the group consisting of mouthwashes, mouthrinses, toothpastes, tooth gels, oral gels, tooth whitening gels, denture cleansers and denture adhesives.

31. The oral treatment kit of claim 30 wherein the oral composition is a toothpaste.

32. The oral treatment kit of claim 30 wherein said container and applicator combination comprises: a pair of flexible foil sheets of substantially identical structure superimposed over one another and permanently fastened together to define there between said container and an outlet to said container from which to express said oral care composition; and wherein said applicator comprises a pair of arcuately spreadable wings for spreading said oral composition onto the surfaces of the oral cavity.

33. The oral treatment kit of claim 32 wherein said container comprises top and bottom surfaces and first and second ends; said top and bottom surfaces having a length and width dimension defining a surface area sufficient in size to receive at least the thumb of a hand, whereby said container may be gripped between the thumb and finger of a hand; and said length and width dimension being substantially greater than the thickness dimension between said top and bottom surfaces to define a relatively thin appearance; said container including a dispensing outlet located at said second end; and an applicator, said applicator being integrally attached to said container to define therewith a unitary one-piece structure; said applicator comprising: first and second wings, each of said wings being integrally attached to and extending outwardly from said second end of said container and being capable of being spread apart pivotally in opposite directions over a wide arc; said first wing being located to one side of said dispensing outlet and said second wing being located to an opposite side of said dispensing outlet; and said first wing defining an applicator surface on an underside surface thereof and said second wing defining an applicator surface on an upperside surface thereof.

34. The oral treatment kit of claim 33 wherein at least one of said flaps of said pair includes on an inner side surface thereof an absorbent pad.

35. The oral treatment kit of claim 30 wherein the container and applicator combination comprises: a pair of flexible sheets, said flexible sheets being connected together to define therebetween a container for confining an oral care composition and an applicator, said applicator comprising a pair of end flaps, one of said flaps integrally formed in an end of one of said flexible sheets in said pair and the other of said flaps being integrally formed in the corresponding end of the other one of said flexible sheets in said pair, and said flaps being positioned in overlying relationship; and a frangible closure integrally formed between said pair of sheets, said closure being normally closed and providing, when open, a passage from said cavity region to said flaps through which said oral care composition may be expressed into at least the region between said flaps, whereby sufficient finger pressure exerted to press said flexible sheets toward one another increases pressure on said confined oral care composition sufficient to express said oral care composition from said cavity region through said passage and into contact with said flaps.

36. The oral treatment kit of claim 35 wherein at least one of said flaps of said pair includes on an inner side surface thereof an absorbent pad.

37. The oral treatment kit of claim 30 wherein the integral package and applicator combination comprises: a relatively flat container having a pair of walls, at least one of said walls of said pair being resilient and said walls being of an area sufficient to permit said container to be gripped and squeezed between the thumb and fingers of one hand; said flat container including an outlet, said outlet being located at an end of said relatively flat container; first and second flaps; said flaps being of a width less than the width of said end of said relatively flat container and said flaps being integrally attached to said end of said container; said first flap being attached to said container at a position above said outlet for swinging movement in one direction and a second one of said flaps being attached to said container at a position below said outlet, in confronting relationship to said first flap, for swinging movement in a second direction opposite to said first direction, whereby said flaps may spread apart to define an applicator and wherein said flat container serves as a handle to said applicator.

38. The oral treatment kit of claim 37 wherein at least one of said flaps of said pair includes on an inner side surface thereof an absorbent pad.
